(19) United States
(12) Patent Application Publication
(10) Pub. No.: US 2006/0143396 A1
(43) Pub. Date: Jun. 29, 2006

(54) Method for programmer-controlled cache line eviction policy

(76) Inventor: Mason Cabot, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,444

(22) Filed: Dec. 29, 2004

(51) Int. Cl. G06F 12/00

(52) U.S. Cl. 711/134

(57) ABSTRACT

A method and apparatus to enable programmatic control of cache line eviction policies. A mechanism is provided that enables programmers to mark portions of code with different cache priority levels based on anticipated or measured access patterns for those code portions. Corresponding cues to assist in effecting the cache eviction policies associated with given priority levels are embedded in machine code generated from source- and/or assembly-level code. Cache architectures are provided that partition cache space into multiple pools, each pool being assigned a different priority. In response to execution of a memory access instruction, an appropriate cache pool is selected and searched based on information contained in the instruction's cue. On a cache miss, a cache line is selected from that pool to be evicted using a cache eviction policy associated with the pool. Implementations of the mechanism or described for both n-way set associative caches and fully-associative caches.

### FIELD OF THE INVENTION

The field of invention relates generally to computer systems and, more specifically but not exclusively relates to techniques to support programmer-controller cache line eviction policies.

### BACKGROUND INFORMATION

General-purpose processors typically incorporate a coherent cache as part of the memory hierarchy for the systems in which they are installed. The cache is a small, fast memory that is close to the processor core and may be organized in several levels. For example, modern microprocessors typically employ both first-level (L1) and second-level (L2) caches on die, with the L1 cache being smaller and faster (and closer to the core), and the L2 cache being larger and slower. Caching benefits application performance on processors by using the properties of spatial locality (memory locations at adjacent addresses to accessed locations are likely to be accessed as well) and temporal locality (a memory location that has been accessed is likely to be accessed again) to keep needed data and instructions close to the processor core, thus reducing memory access latencies.

In general, there are three types of overall cache schemes (with various techniques for implementing each scheme). These include the direct-mapped cache, the fully-associative cache, and the N-way set-associative cache. Under a direct-mapped cache, each memory location is mapped to a single cache line that it shares with many others; only one of the many addresses that share this line can use it at a given time. This is the simplest technique both in concept and in implementation. Under this cache scheme, the circuitry to check for cache hits is fast and easy to design, but the hit ratio is relatively poor compared to the other designs because of its inflexibility.

Under fully-associative caches, any memory location can be cached in any cache line. This is the most complex technique and requires sophisticated search algorithms when checking for a hit. It can lead to the whole cache being slowed down because of this, but it offers the best theoretical hit ratio, since there are so many options for caching any memory address.

n-way set-associative caches combine aspects of direct-mapped and fully-associative caches. Under this approach, the cache is broken into sets of n lines each (e.g., n=2, 4, 8, etc.), and any memory address can be cached in any of those n lines. Effectively, the sets of cache line are logically partitioned into n groups. This improves hit ratios over the direct mapped cache, but without incurring a severe search penalty (since n is kept small).

Overall, caches are designed to speed-up memory access operations over time. For general-purpose processors, this dictates that the cache scheme work fairly well for various types of applications, but may not work exceptionally well for any single application. There are several considerations that affect the performance of a cache scheme. Some aspects, such as size and access latency, are limited by cost and process limitations. For example, larger caches are expensive since they use a very-large number of transistors and thus are more expensive to fabricate both in terms of semiconductor size and yield reductions. Access latency is generally determined by the fabrication technology and the clock rate of the processor core and/or cache (when different clock rates are used for each).

Another important consideration is cache eviction. In order to add new data and/or instructions to a cache, one or more cache lines are allocated. If the cache is full (normally the case after start-up operations), the same number of existing cache lines must be evicted. Typically eviction policies include random, least recently used (LRU) and pseudo LRU. Under current practices, the allocation and eviction policies are performed by corresponding algorithms that are implemented by the cache controller hardware. This leads to inflexible eviction policies that may be well-suited for some types of applications, while providing poor-performance for other types of applications, wherein the cache performance level is dependent on the structure of the application code.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a typical memory hierarchy employed in modern computer systems;

FIG. 2 is a flowchart illustrating operations performed during a conventional caching process;

FIG. 3a is a flowchart illustrating operations and logic performed under a caching process that supports programmatic control of cache eviction policies, wherein caches are partitioned into high- and low-priority pools, according to one embodiment of the invention;

FIG. 3b is a flowchart illustrating operations and logic performed under a caching process that supports programmatic control of cache eviction policies, wherein caches are partitioned into multiple priority pools having respective priority levels, according to one embodiment of the invention;

FIG. 4 is a flowchart illustrating operations performed during program design, code generation and run-time phases, wherein a programmer is enabled to identify portions of an application program that are to have prioritized caching, and prioritized caching of such identified portions is performed during execution of the generated program machine code, according to one embodiment of the invention;

FIG. 5a is a pseudocode listing illustrating exemplary pragma statements used to delineate portions of code that are assigned a high cache priority level, according to one embodiment of the invention;

FIG. 5b is a pseudocode listing illustrating exemplary pragma statements used to delineate portions of code that are assigned to multiple cache priority levels, according to one embodiment of the invention;

FIG. 6 is a flowchart operations performed during program design, code generation and run-time phases, wherein memory access patterns of original program code is monitored to determined portions of the code that are suitable for prioritized caching, with such portions being manually or automatically marked and the original code being re-compiled to include replacement op codes that are used to effect prioritized caching operations, according to one embodiment of the invention;

FIG. 7a is a schematic diagram of a 4-way set associative cache architecture under which one of the groups of cache lines is assigned to a high priority pool, while the remaining groups of cache lines are assigned to a low priority pool;

FIG. 7b is a schematic diagram illustrating a various of the cache architecture of FIG. 7a, wherein each group of cache lines is assigned to a respective pool having a different priority level;

FIG. 8a is a schematic diagram of a fully-associative cache architecture under which cache lines are assigned to one of a high- or low-priority pool via a pool priority bit;

FIG. 8b is a schematic diagram of a fully-associative cache architecture under which cache lines are assigned to one of m priority levels using a multi-bit pool identifier;

FIG. 8c is a schematic diagram illustrating an optional configuration of the cache architecture of a FIG. 8b, wherein an MESI (Modified Exclusive Shared and Invalid) protocol is employed; and

FIG. 9 is a schematic diagram illustrating an exemplary computer system and processor on which cache architecture embodiments described herein may be implemented.

### DETAILED DESCRIPTION

Embodiments of methods and apparatus for enabling programmer-controlled cache line eviction policies are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

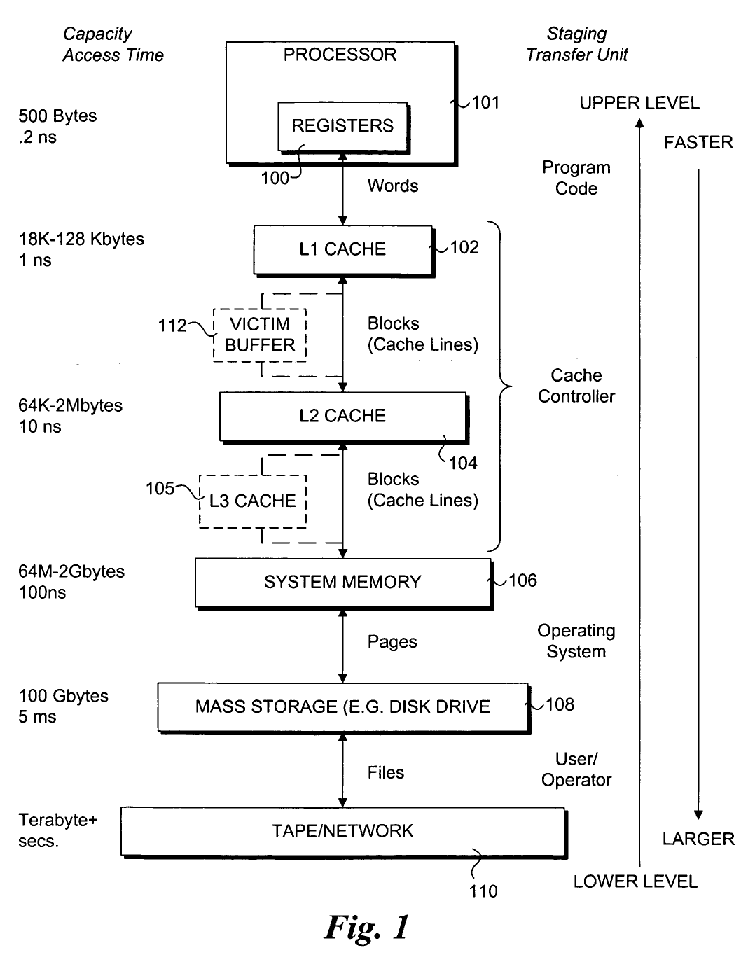

A typical memory hierarchy model is shown in FIG. 1. At the top of the hierarchy are processor registers 100 in a processor 101, which are used to store temporal data used by the processing core, such as operands, instruction op codes, processing results, etc. At the next level are the hardware caches, which generally include at least an L1 cache 102, and typically further include an L2 cache 104. Some processors also provide an integrated level 3 (L3) cache 105. These caches are coupled to system memory 106 (via a cache controller), which typically comprises some form of DRAM—(dynamic random access memory) based memory. In turn, the system memory is used to store data that is generally retrieved from one or more local mass storage devices 108, such as disk drives, and/or data stored on a backup store (e.g., tape drive) or over a network, as depicted by tape/network 110.

Many newer processors further employ a victim cache (or victim buffer) 112, which is used to store data that was recently evicted from the L1 cache. Under this architecture, evicted data (the victim) is first moved to the victim buffer, and then to the L2 cache. Victim caches are employed in exclusive cache architectures, wherein only one copy of a particular cache line is maintained by the various processor cache levels.

As depicted by the exemplary capacity and access time information for each level of the hierarchy, the memory near the top of the hierarchy has faster access and smaller size, while the memory toward the bottom of the hierarchy has much larger size and slower access. In addition, the cost per storage unit (Byte) of the memory type is approximately inverse to the access time, with register storage being the most expensive, and tape/network storage being the least expensive. In view of these attributes and related performance criteria, computer systems are typically designed to balance cost vs. performance. For example, a typically desktop computer might employ a processor with a 16 Kbyte L1 cache, a 256 Kbyte L2 cache, and have 512 Mbytes of system memory. In contrast, a higher performance server might use a processor with much larger caches, such as provided by an Intel® Xeon™ MP processor, which may include a 20 Kbyte (data and execution trace) cache, a 512 Kbyte L2 cache, and a 4 Mbyte L3 cache, with several Gbytes of system memory.

One motivation for using a memory hierarchy such as depicted in FIG. 1 is to segregate different memory types based on cost/performance considerations. At an abstract level, each given level effectively functions as a cache for the level below it. Thus, in effect, system memory 106 is a type of cache for mass storage 108, and mass storage may even function as a type of cache for tape/network 110.

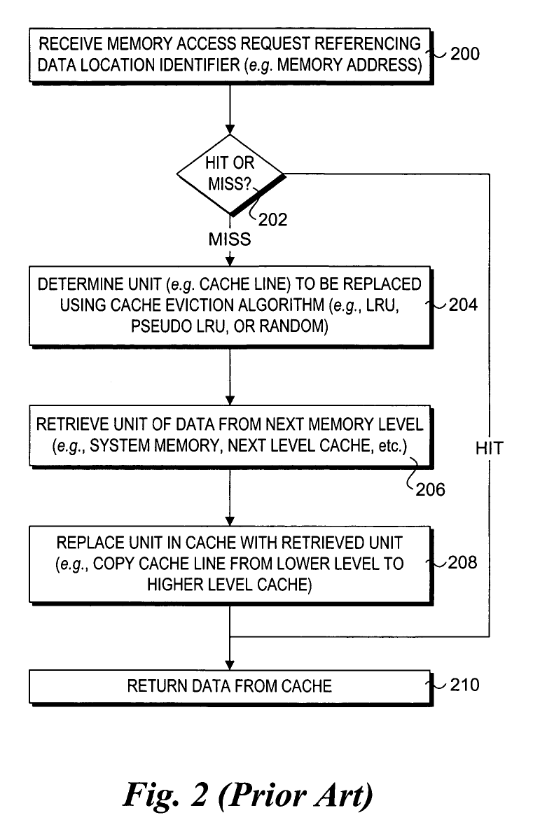

With these considerations in mind, a generalized conventional cache usage model is shown in FIG. 2. The cache usage is initiated in a block 200, wherein a memory access request is received at a given level referencing a data location identifier, which specifies where the data is located in the next level of the hierarchy. For example, a typical memory access from a processor will specify the address of the requested data, which is obtained via execution of corresponding program instructions. Other types of memory access requests may be made at lower levels. For example, an operating system may employ a portion of a disk drive to function as virtual memory, thus increasing the functional size of the system memory. In doing so, the operating system will “swap” memory pages between the system memory and disk drive, wherein the pages are stored in a temporary swap file.

In response to the access request, a determination is made in a decision block 202 to whether the requested data is in the applicable cache—that is the (effective) cache at the next level in the hierarchy. In common parlance, the existence of the requested data is a “cache hit”, while the absence of the data results in a “cache miss”. For a processor request, this determination would identify whether the requested data was present in L1 cache 102. For an L2 cache request (issued via a corresponding cache controller), decision block 202 would determine whether the data was available in the L2 cache.

If the data is available in the applicable cache, the answer to decision block 202 is a HIT, advancing the logic to a block 210 in which data is returned from that cache to the requester at the level immediately above the cache. For example, if the request is made to L1 cache 102 from the processor and the data is present in the L1 cache, it is returned to the processor (the requester). However, if the data is not present in the L1 cache, the cache controller issues a second data access request, this time from the L1 cache to the L2 cache. If the data is present in the L2 cache, it is returned to the L1 cache, the current requester. As will be recognized by those skilled in the art, under an inclusive cache design, this data would then be written to the L1 cache and returned from the L1 cache to the processor. In addition to the configurations shown herein, some architectures employ a parallel path, whether the L2 cache returns data to the L1 cache and the processor simultaneously.

Now let's suppose the requested data is not present in the applicable cache, resulting in a MISS. In this case, the logic proceeds to a block 204, wherein the unit of data to be replaced (by the requested data) is determined using an applicable cache eviction policy. For example, in an L1, L2, and L3 caches, the unit of storage is a “cache line” (the unit of storage for a processor cache is also referred to a block, while the replacement unit for system memory typically is a memory page). The unit that is to be replaced comprises the evicted unit, since it is evicted from the cache. The most common algorithms used for conventional cache eviction are LRU, pseudo LRU, and random.

In conjunction with the operations of block 204, the requested unit of data is retrieved from the next memory level in a block 206, and used to replace the evicted unit in a block 208. For example, suppose the initial request was made by a processor, and the requested data is available in the L2 cache, but not the L1 cache. In response to the L1 cache miss, a cache line to be evicted from the L1 cache will be determined by the cache controller in a block 204. In parallel, a cache line containing the requested data in L2 will be copied into the L1 cache at the location of the cache line selected for eviction, thus replacing the evicted cache line. After the cache data unit is replaced, the applicable data contained within the unit is returned to the requester in block 210.

Under the conventional scheme, cache eviction policies are static. That is, they are typically implemented via programmed logic in the cache controller hardware, which cannot be changed. For instance, a particular processor model will have a specific cache eviction policy embedded into its cache controller logic, requiring that eviction policy to be employed for all applications that are run on systems employing the processor.

In accordance with embodiments of the invention, mechanisms are provided for controlling cache eviction policies via programmatic control elements. This enables a programmer or compiler to embed control cues in his or her source code to instruct the cache controller how selected-portions of the corresponding machine code (derived from the source code) and/or data are to be cached via use of program-controlled eviction policies.

As an overview, a basic embodiment of the invention will first be discussed to illustrate general aspects of the programmatic cache policy control mechanism. Additionally, an implementation of this embodiment using a high-level cache (e.g., L1, L2, or L3 cache) will be described to illustrate general principles employed by the mechanism. It will be understood that these general principles may be implemented at other cache levels in a similar manner, such as at the system memory level.

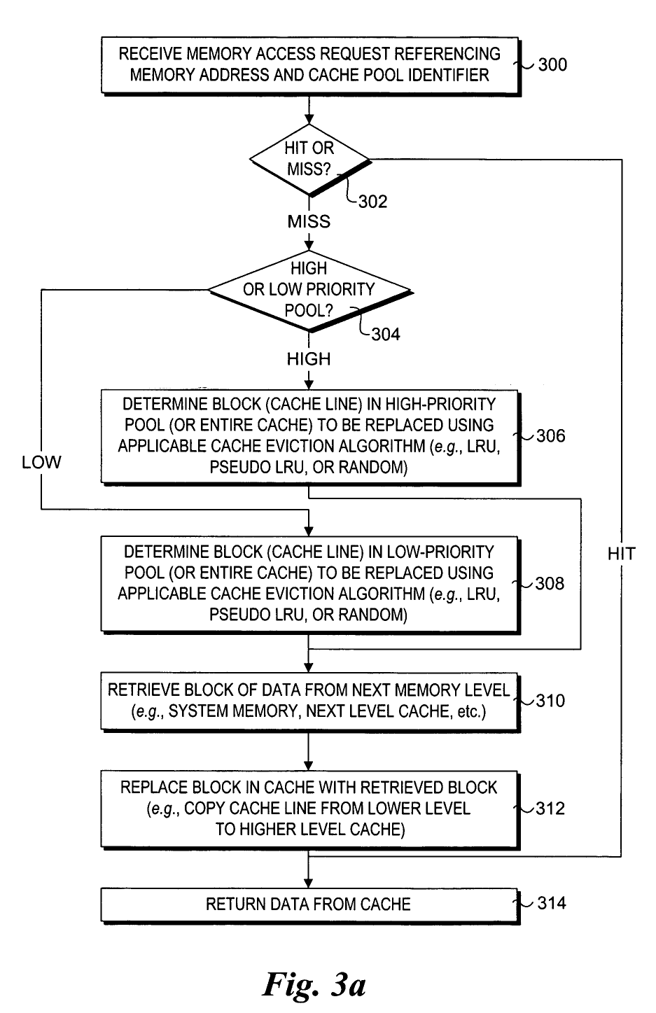

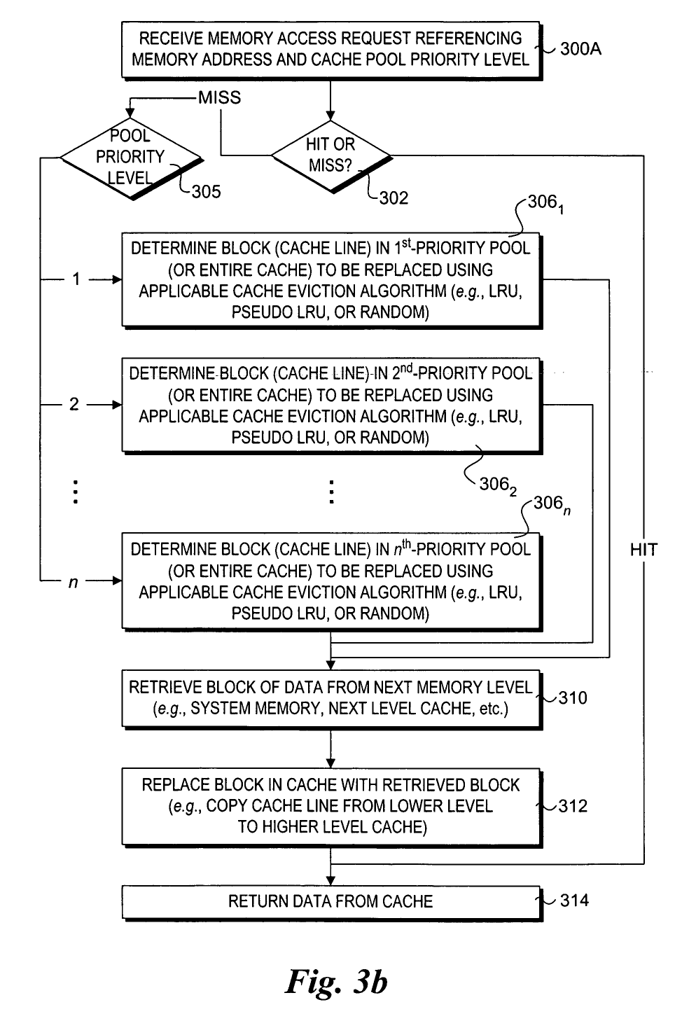

With reference to FIG. 3a, a flowchart is shown illustrating operations and logic performed under one implementation of the basic embodiment. Under this implementation, the storage resources for a given cache level are partitioned into two pools: a high-priority pool and a low-priority pool. The high-priority pool is used to store cache lines containing data and/or code that is more likely to be re-accessed in the near future by the processor, while the low-priority pool is used to store cache lines containing data and/or code that is less likely to be re-accessed during this timeframe. Furthermore, the high-priority pool is selected to store cache lines that would be normally evicted under conventional cache eviction schemes. According to additional aspects of the implementation, cues are embedded in the machine code to instruct the cache controller into which pools blocks containing the requested data are to be cached.

Beginning at a block 300, the memory access cycle proceeds in a similar manner to the conventional approach, with the requester (the processor in this example) issuing a memory access request referencing the address of the data and/or instruction to be retrieved. However, the request further includes a cache pool identifier (ID), which is used to specify the cache pool in which the retrieved data are to be cached. Further details for implementing this aspect of the mechanism are described below.

As before, in response to the memory access request, the applicable cache level checks to see if the data is present or not, as depicted by a decision block 302. In some embodiments, the cache pool ID is employed to assist in the corresponding cache search, as described below. If a cache HIT results, the data is returned to the requester in a block 314, completing the cycle. However, if a cache MISS results, the logic proceeds to a decision block 304, wherein a determination is made to whether the cache pool ID specifies the high- or low-priority pool.

If the cache pool ID specifies the high-priority pool, the data and/or instructions corresponding to the request have been identified by the programmer to be included in portions of an application program that are likely to be accessed at a higher frequency than other portions of the application (yet not frequently enough to remain in the cache under conventional eviction policies). As such, it is desired to mark the corresponding cache lines in which the requested data are to be stored such that those cache lines are less-frequently evicted when compared with low-priority cache lines. If the cache pool ID specifies the low-priority pool, this indicates that the associated portion of the application is deemed by the programmer to be less-frequently accessed. In one embodiment, high-priority pool IDs comprise an asserted bit, while low priority IDs comprise a non-asserted bit. As described in further detail below, in one embodiment portions of an application containing high-priority data and code are marked to be cached in the high-priority pool, while all other data and code is simply cached in the low-priority or “default” pool by default.

According to the results of decision block 304, requests with high-priority pool IDs are initially processed by a block 306. In this block, a determination is made to which data block (cache line) is to be replaced using the applicable cache eviction policy (and associated algorithm) for the pool. In one embodiment, respective portions of the cache storage space are partitioned into fixed-sized high- and low-priority pools. In this case, the cache line to be replaced is selected from among the cache lines in the high-priority pool, using the applicable cache eviction algorithm. For example, in one embodiment an LRU algorithm may be used to evict the least recently used cache line from the high-priority pool, while other embodiments may employ optional algorithms, including but not limited to pseudo LRU or random eviction algorithms.

In another embodiment, the size of the high- and low-priority pools is variable. In this case, the logic in the cache controller is adapted such that the relative size of the pools may be dynamically adjusted in view of program directives (e.g., cues) and/or monitored access patterns. In one embodiment, the cache controller logic employs a cache eviction policy that dynamically adjusts the relative size of the pools based on an observed ratio of high- and low-priority pool requests. In one embodiment, a single cache eviction policy is implemented for both cache pools. In another embodiment, respective secondary cache eviction policies are applied to the dynamically-adjusted high- and low-priority sub-pools.

The low-priority pool entries are handled in a similar manner to the high-priority pool entries in a block 308. As discussed above, in one embodiment a fixed portion of the cache is allocated to the low-priority pool. Accordingly, a separate low-priority pool cache eviction policy is applied to this portion of the cache. Also as discussed above, under embodiments in which the size of the high- and low-priority pools may be dynamically adjusted, a single cache eviction policy may be applied to the whole cache, or respective secondary cache eviction policies may be applied to the dynamically-adjusted high- and low-priority sub-pools.

In conjunction with the operations of blocks 306 and 308 (as applicable), the requested block of data is retrieved from the next memory level in a block 310 and is used to replace the block selected for eviction in a block 312. Under one embodiment of an L2-to-L1 cache replacement or an L3-to-L2 cache replacement, a cache line in the lower level cache is simply copied into the location previously occupied by the evicted cache line in the upper level cache, and new values are inserted into the corresponding cache line tag. After the requested data has been written to the high-level cache, it is returned to the processor.

The general principles presented above for the high- and low-priority pool embodiments may be extended to support any number of cache priority levels. For example, the embodiment of FIG. 3b supports from 1 to n cache pool priority levels. In one embodiment, n is the number of ways in an n-way associative cache. In another embodiment, n cache priority pools are implemented using a fully-associative cache. In yet another embodiment, n cache priority pools are implemented on an m-way set-associate cache, wherein n≠m.

Returning to the embodiment of FIG. 3b, the memory access cycle begins at a block 300A in a manner similar to that discussed above for block 300 of FIG. 3a, but rather than identifying the cache pool, data specifying a cache priority level is provided along with the memory address. In accordance with a cache HIT or MISS determination made by a decision block 302, the logic proceeds to either block 314 or a decision block 305. In one embodiment the cache pool priority level is used to assist in the cache search, while the cache pool priority level is not employed during cache searches under other embodiments.

Decision block 305 is used to branch the logic into one of n blocks that are used to implement a respective cache eviction policy for the corresponding priority level. For example, if the cache pool priority level is 1, the logic is routed to a block 306₁, if it is 2, the logic is routed to a block 306₂, etc. In a manner similar to that described above, under one embodiment the cache is partitioned into n pools of fixed size, wherein the pool sizes may or may not be equal. In another embodiment, the pools sizes are dynamically adjusted in view of ongoing access pattern considerations. In each of blocks 306₁₋ₙ, a respective cache eviction policy is applied in view of the corresponding cache pool priority level. In general, the same type of cache eviction policy may be applied for each priority level, or different types of eviction policies (and corresponding algorithms) may be implemented for the different levels. After the cache line to be replaced is determined by the eviction policy in one of blocks 306₁₋ₙ, the requested data is retrieved from the next memory level in block 310 and the evicted cache line is replaced in block 312 in a similar manner to that discussed above for like-numbered blocks in FIG. 3a. The newly-cached data is then returned to the requesting processor in block 314.

In general, one of several techniques may be employed to mark the cache pool priority level of respective portions of application code. Eventually, however, cache priority level indicia will be encoded into machine-level code that is suitable to be run on the target processor, since processors do not execute source-level code. As described below in further detail, in one embodiment special op codes are added to a processor's instruction set to instruct the processor into which pool corresponding data and instructions are to be cached.

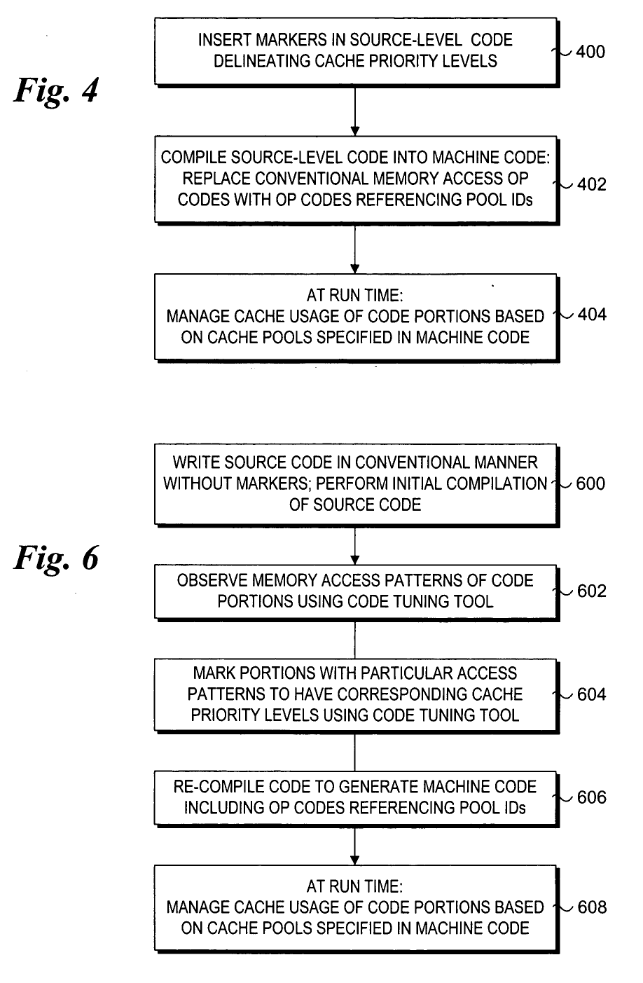

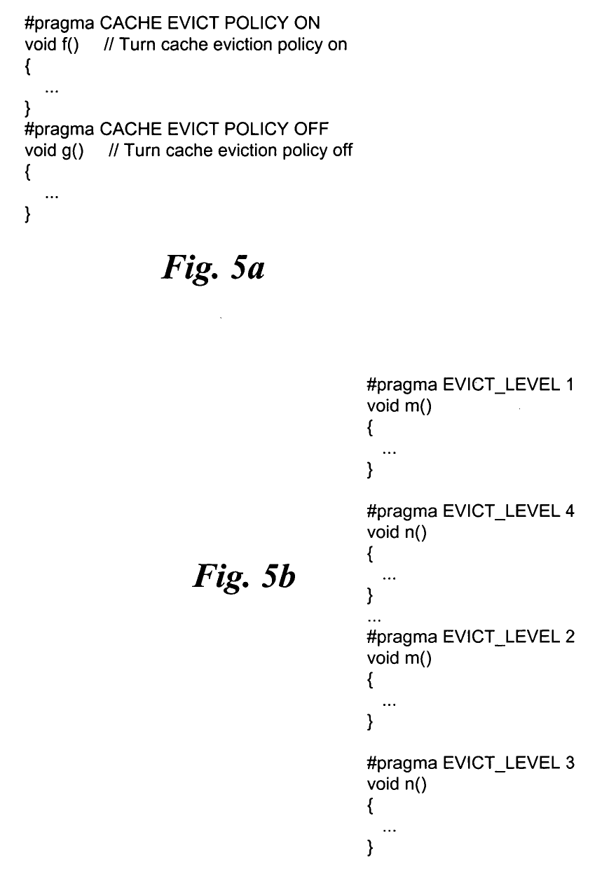

In one embodiment, markers are embedded at the source code level, resulting in the generation of corresponding cache priority cues in the machine code. With reference to FIG. 4, this process begins at a block 400 in which markers are inserted into high-level source code to delineate cache eviction policies for the different code portions. In one embodiment, the high-level code comprises programming code written in the C or C++ language, and the markers are implemented via corresponding pragma statements. Pseudocode illustrating a set of exemplary pragma statements to effect a two-priority-level cache eviction policy is shown in FIG. 5a. In this embodiment, there are two priority levels: ON, indicating high priority, and OFF, indicating low priority, or the default priority level. The pragma statement “CACHE EVICT POLICY ON” is used to mark the beginning of a code portion that is to be assigned to the high-priority pool, while the “CACHE EVICT POLICY OFF” pragma statement is used to mark the end of the code portion.

In another embodiment, pragma statements are used to delineate n cache priority levels. For example, pseudocode illustrating pragma statements for effecting four different cache priority levels is shown in FIG. 5b. In this case, the pragma “EVICT_LEVEL 1” is used to delineate the start of a code portion for which a level 1 cache priority is to be applied, “EVICT_LEVEL 2” is used to delineate the start of a code portion for which a level 2 cache priority is to be applied, etc.

These pragma statements shown in FIGS. 5a and 5b instruct the compiler to generate machine code that includes embedded cues instructing the processor and/or cache controller into which pool the corresponding code and/or data is to be cached, and thus (indirectly) which cache eviction policy is to be used. In one embodiment, this is accomplished by replacing conventional memory access op codes with new op codes that provide a means for informing the processor and/or cache controller what cache pool priority level should be used for caching the corresponding code portions, as shown in a block 402.

In one embodiment, an explicit op code is provided for each respective cache priority level. For example, under one common instruction set, the MOV instruction is used to move data between memory and registers. For two cache priority levels, the corresponding assembly instructions might be MOV (specifying a low priority cache pool that is a default or no special handling is requested), MOVL (explicitly specifying use of the low-priority pool) and MOVH (explicitly specifying use of the high-priority pool). In another embodiment, a respective op code is provided for each priority level, such as MOV1, MOV2, MOV3, etc. In one embodiment of an n priority level implementation, the instruction comprises an instruction and an attribute that defines the priority level, such as MOVC n.

In another embodiment, instructions are used to explicitly set and clear a flag or multi-bit pool ID register. Under this approach, the flag or multi-bit pool ID register is checked in conjunction with decoding selected memory access instructions, with the flag or pool ID value identifying which pool should be used for caching the applicable data and/or instructions corresponding to the memory access. In this manner, a register value can be set to identify a certain pool, with caching of data related to the current access and subsequent access being assigned to that pool. In order to change the pool, the flag or pool ID value is changed accordingly. Under one set of exemplary instruction formats, a SETHF is used to set a high priority pool flag, while a CLRHF is used to clear the flag (indicating a low-priority or default pool should be used). Under one embodiment of a n priority level implementation, the instruction comprises instruction and an attribute that defines the priority level, such as SETP n.

As shown in a block 404, at run time the cache usage is managed via directional cues (the specific op codes and optional operands) contained in the executed machine code. Techniques showing hardware implementations for effectuating the cache eviction policies are discussed below.

In addition to using pragmas in high-level source code, machine-level code portions may be marked with different priority levels using a code tuning tool or the like. For example, code tuning tools, such as Intel's® Vtune, may be used to monitor code access during run-time usage of application programs. These tools enable the programmer to identify code portions that are more frequently used than other portions. Furthermore, the usage cycles may also be identified. This is especially beneficial for implementing certain cache eviction policies that may be facilitated by the embodiments described herein. For example, under a conventional LRU eviction algorithm, code portions with very high access are loaded into a cache and stay in the cache until they become the least-recently used cache lines. In effect, this is a type of high-priority caching.

In contrast, embodiments of the invention enable programmers to effect cache eviction policies for other types of situations that are not efficiently handled by existing cache-wide eviction algorithms. For example, suppose there is a particular portion of code that is used fairly often over relatively-long periods of time (long-term temporal locality), yet continues to be evicted between uses under a conventional eviction algorithm. Meanwhile, other portions of code are used sparingly, wherein the use of the highest-level cache is actually counterproductive. This is especially true under an exclusive cache design, wherein only one copy of data is maintained in the various processor caches (e.g., only one copy of data exists in either an L1 cache or L2 cache at a time, but not both).

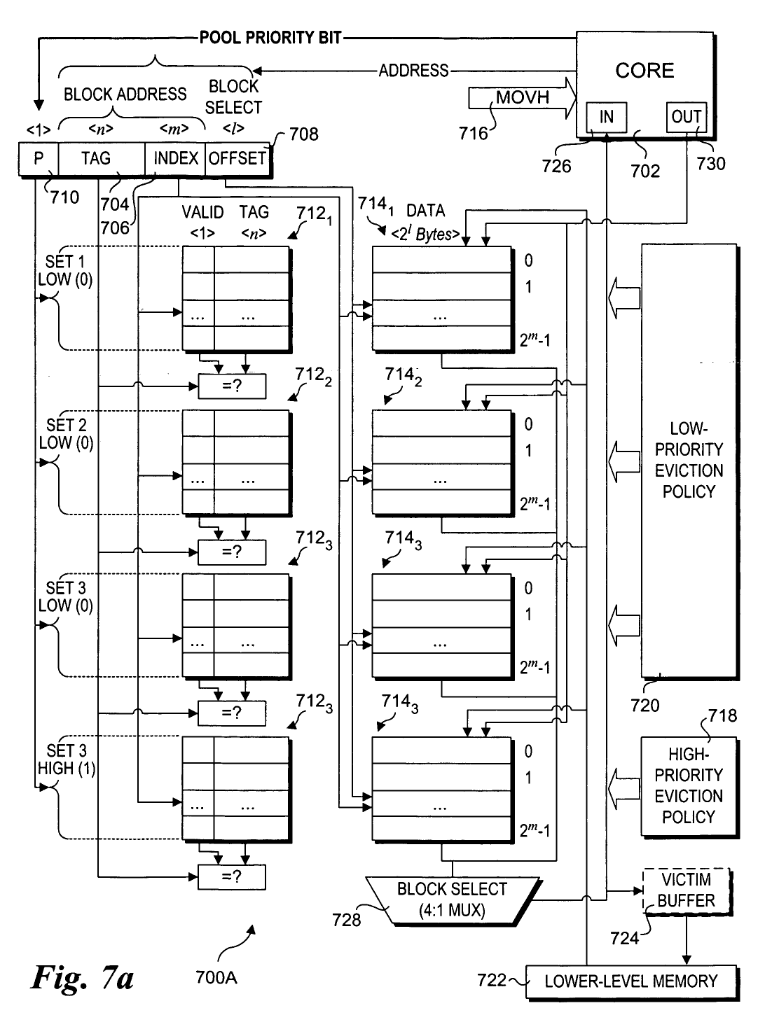

FIG. 6 shows a flowchart illustrating operations performed to generate code portions having cache priority levels derived from observation of actual application usage. The process starts in a block 600, wherein source code is compiled in the conventional manner without markers. In a block 602, memory access patterns for the compiled code is observed using an appropriate code tuning tool or the like. The code portions with particular access patterns are then marked using the tuning tool in a block 604, either under direction of a user or automatically via logic built into the tuning tool. The tuning tool then re-compiles the code to generate new code including instructions with embedded cache management directives (e.g., via explicit op codes similar to those described herein).

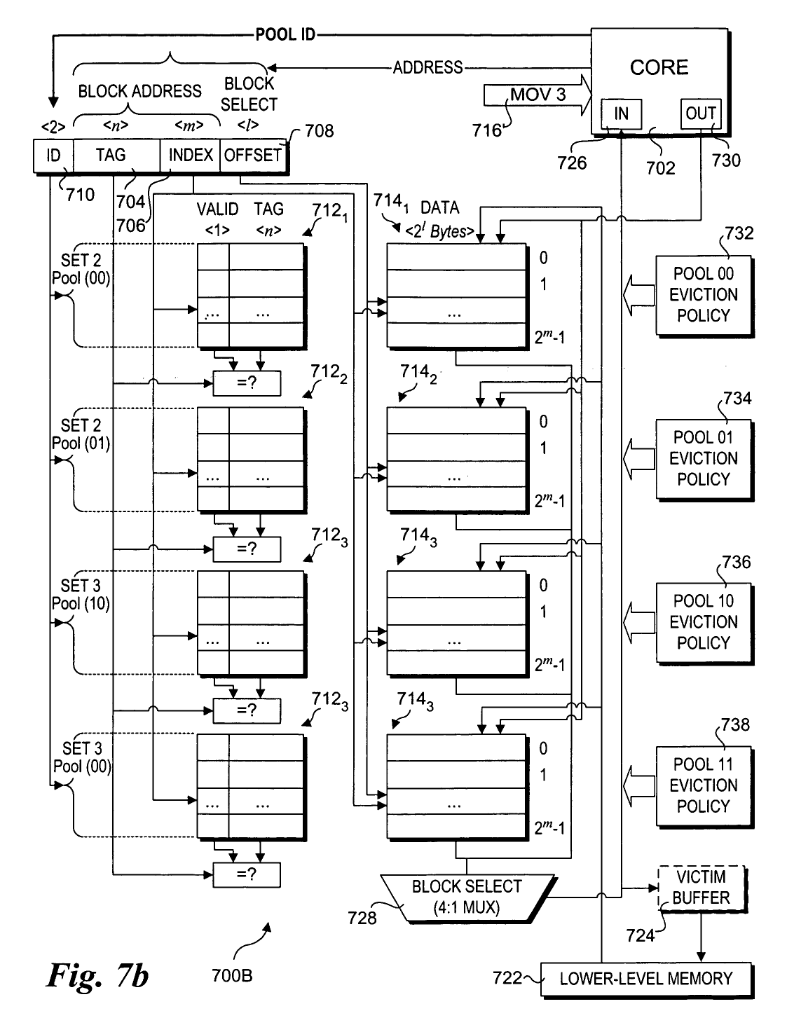

Exemplary embodiments of hardware architectures to support programmatic control of cache eviction policies are shown in FIGS. 7a-b, and 8a-c. In general, the principles disclosed in these embodiments may be implemented on various types of well-known cache architectures, including n-way set associative cache architectures and fully-associative cache architectures. Furthermore, the principles may be implemented on both unified caches (cache and data in the same cache) and Harvard architecture caches (cache divided into a data cache (Dcache) and an instruction cache (Icache). It is further noted that details of other cache components, such a multiplexers, decode logic, data ports, etc. are not shown for clarity in FIGS. 7a-b and 8a-c. It will be understood by those skilled in the art that these components would be present in an actual implementation of the architectures.

The cache architecture 700A embodiment of FIG. 7a corresponds to a 4-way set associative cache. In general, this architecture is representative of an n-way set associative cache, with a 4-way implementation detailed herein for clarity. The main components of the architecture include a processor 702, various cache control elements (specific details of which are described below) collectively referred to as a cache controller, and the actual cache storage space itself, which is comprised of memory used to store tag arrays and cache lines, also commonly referred to a blocks.

The general operation of cache architecture 700A is similar to that employed by a conventional 4-way set associative cache. In response to a memory access request (made via execution of a corresponding instruction or instruction sequence), an address referenced by the request is forwarded to the cache controller. The fields of the address are partitioned into a TAG 704, an INDEX 706, and a block OFFSET 708. The combination of TAG 704 and INDEX 706 is commonly referred to as the block (or cache line) address. Block OFFSET 708 is also commonly referred to as the byte select or word select field. The purpose of a byte/word select or block offset is to select a requested word (typically) or byte from among multiple words or bytes in a cache line. For example, typical cache lines sizes range from 8-128 bytes. Since a cache line is the smallest unit that may be accessed in a cache, it is necessary to provide information to enable further parsing of the cache line to return the requested data. The location of the desired word or byte is offset from the base of the cache line, hence the name block “offset.”

Typically, l least significant bits are used for the block offset, with the width of a cache line or block being 2^{l} bytes wide. The next set of m bits comprises INDEX 706. The index comprises the portion of the address bits, adjacent to the offset, that specify the cache set to be accessed. It is m bits wide in the illustrated embodiment, and thus each array holds 2^{m} entries. It is used to look up a tag in each of the tag arrays, and, along with the offset, used to look up the data in each of the cache line arrays. The bits for TAG 704 comprises the most significant n bits of the address. It is used to lookup a corresponding TAG in each TAG array.

All of the aforementioned cache elements are conventional elements. In addition to these elements, cache architecture 700A employs a pool priority bit 710. The pool priority bit is used to select a set in which the cache line is to be searched and/or evicted/replaced (if necessary). Under cache architecture 700A, memory array elements are partitioned into four groups. Each group includes a TAG array 712ⱼ and a cache line array 714ⱼ, wherein j identifies the group (e.g., group 1 includes a TAG array 712, and a cache line array 714₁).

In response to a memory access request, operation of cache architecture 700A proceeds as follows. In the illustrated embodiment, processor 702 receives a MOVH instruction 716 referencing a memory address. As discussed above, in one embodiment a MOVH instruction instructs the processor/cache controller to store a corresponding cache line in the high priority pool. In the illustrated embodiment, the groups 1, 2, 3 and 4 are partitioned such that groups 1-3 are employed for the low-priority pool, while group 4 is employed for the high-priority pool. Other partitioning schemes may also be implemented in a similar manner, such as splitting the groups evenly, or using a single pool for the low-priority pool while using the other three pools for the high-priority pool.

In response to execution of the MOVH instruction, a priority bit having a high logic level (1) is appended as a prefix to the address and provided to the cache controller logic. In one embodiment, the high priority bit is stored in one 1-bit register, while the address is stored in another w-bit register, wherein w is the width of the address. In another embodiment, the combination of the priority bit and address are stored in a register that is w+1 wide.

Under one embodiment of a segregated pool scheme, such as that shown in FIG. 7a, only those groups having pools associated with the priority bit value for the current request need to be searched to verify a cache hit or miss. Thus, only TAG array 712₄ needs to be searched. Under the illustrated embodiment, each element in a TAG array includes a valid bit. This bit is used to indicate whether a corresponding cache line is valid, and must be set for a match. In this example, it will be assumed that a cache miss occurs.

In response to the cache miss, the cache controller selects a cache line from group 4 to be replaced. In the illustrated embodiment, separate cache eviction policies are implemented for each of the high- and low-priority pools, depicted as a high-priority eviction policy 718 and a low-priority eviction policy 720. In another embodiment, a common eviction policy may be used for both pools (although the cache lines to be evicted are still segregated by priority level).

It is important that modified data in an evicted cache line be written back to system memory prior to eviction. Under a typical approach, a “dirty” bit is used to mark cache lines that have been updated. Depending on the implementation, cache lines with dirty bits may be periodically written back to system memory (followed by clearing the corresponding dirty bits), and/or they may be written back in response to an eviction. If the dirty bit is cleared, there is no need for a write back in connection with a cache line eviction.

Another operation performed in conjunction with selection of the cache line to evict is the retrieval of the requested data from lower-level memory 722. This lower-level memory is representative of a next lower level in the memory hierarchy of FIG. 1, as relative to the current cache level. For example, cache architecture 700A may correspond to an L1 cache, while lower-level memory 722 represents an L2 cache, cache architecture 700A corresponds to an L2 cache, and lower-level memory 722 represents system memory, etc. For simplicity, it is assumed the requested data is stored in lower-level memory 722. In further conjunction with selection of the cache line to evict, under an optional implementation of cache architecture 700 having an exclusive cache architecture employing a victim buffer 724, such as illustrated in FIG. 7a, the cache line is copied to the victim buffer.

Upon return of the requested data to the cache controller, the data are copied into the evicted cache line, and the corresponding TAG and valid bit is updated in the appropriate TAG array (TAG array 7124 in the present example). Rather than return just the requested data, a number of sequential bytes of data proximate to and including the requested data is returned, wherein the number of bytes is equal to the cache line width. For example, for a cache line width of 32 Bytes, 32 Bytes of data would be returned. A word (corresponding to the original request) contained in the new cache line is then read from the cache into an input register 726 for processor 702, with the assist of a 4:1 block selection multiplexer 728.

Writing a value corresponding to an un-cached address and updating a value stored in a cache line for cache architecture 700A is also performed in a manner similar to the conventional approach, except for the further use of the pool priority bit. This involves a cache write-back, under which data stored in an output register 730 is to be written to system memory (eventually). The appropriate cache line (should such presently exist) is first searched using the group(s) associated with the pool defined by the pool priority bit. If found, the cache line is updated with the data in output register 730, and a corresponding dirty bit (not shown) is flagged. The system memory is subsequently updated with the new value via well-known write-back operations. If the data to be updated is not found in the cache, under one embodiment a cache line is evicted in a manner similar to that described above for a read request, and a block including the data to be updated is retrieved from system memory (or the next level cache, as appropriate). This block is then copied to the evicted cache line and the corresponding TAG and valid bit values are updated in an appropriate TAG array. In some instances, it is desired to bypass caching operations when updating system memory. In this instance, the data at the memory address is updated without caching to corresponding block.

Cache architecture 700B of FIG. 7b is similar in configuration to cache architecture 700A of FIG. 7a, wherein like-numbered components perform similar functions. Under this architecture, a four-level cache eviction priority scheme is implemented, which is generally representative of an n-level eviction priority scheme. Under this scheme, each group is associated with a respective pool, with each pool being assigned a respective priority level. The previous single priority bit is replaced with a multi-bit field, with the bit width dependent on the number of priority levels to be implemented based on a power of two. For example, in the case of the four priority levels depicted in FIG. 7b, two bits are used. In addition, each respective pool has an associated pool eviction policy, as depicted by a pool 00 eviction policy 732, a pool 01 eviction policy 734, a pool 10 eviction policy 736, and a pool 10 eviction policy 738.

Cache architecture 700B works in a similar manner to that described above for cache architecture 700A. However, in this instance, the pool ID value, which identifies the priority of the request, is used to identify the appropriate cache pool, and thus appropriate cache set.

It is noted that a combination of features provided by cache architectures 700A and 700B may be implemented in the same cache. For example, an n-way set associative cache may employ m priority levels, where n≠m.

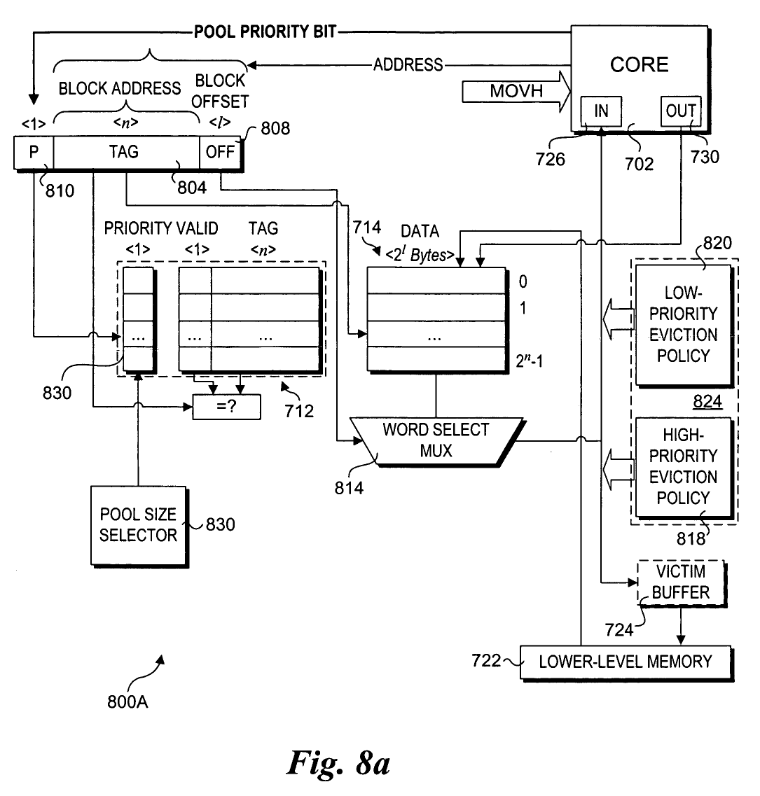

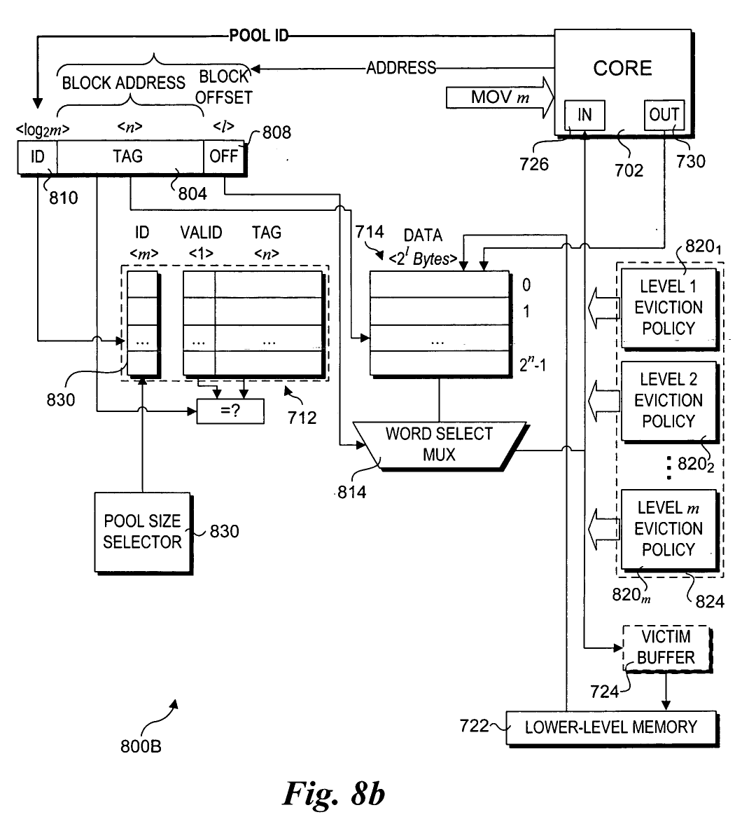

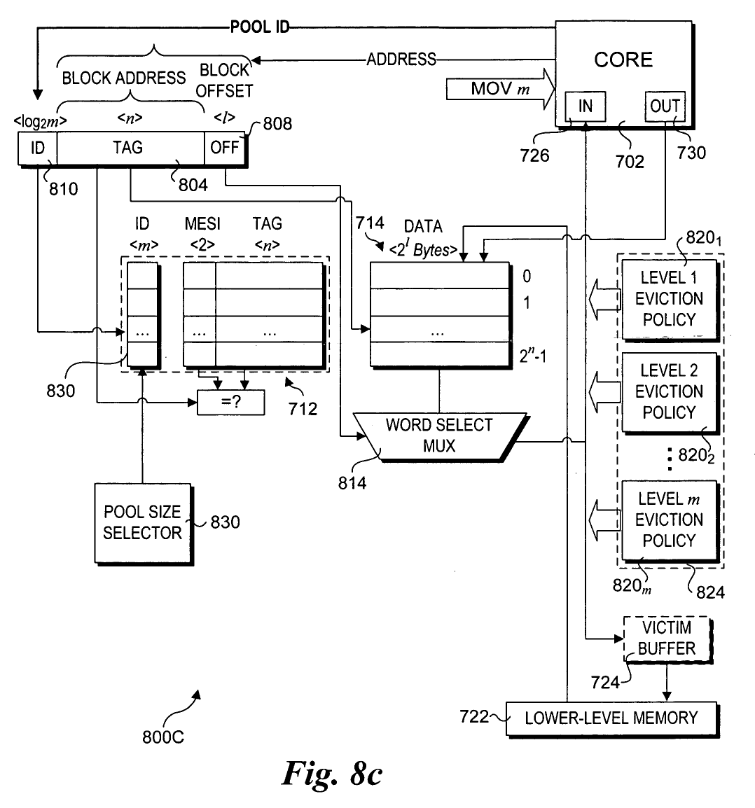

FIGS. 8a-c depict fully-associative cache architectures that have been extended to support programmatic control of cache policies. A fully-associative cache functions like a single-set associative cache. Thus, each of cache architecture 800A, 800B, and 800C (of respective FIGS. 8a, 8b, and 8c) include a single TAG array 712 and a single cache line array 714. Since there is only a single set of TAGs and cache lines, there is no need for an INDEX, and thus the information provided to the cache controller now includes a TAG 804, representing the block address, and a block offset 808. In a manner analogous to cache architecture 700A, cache architecture 800A of FIG. 8a employs a pool priority bit 810, which performs a similar function to pool priority bit 710 discussed above.

Unlike cache architectures 700A and 700B, each of cache architectures 800A, 800B, and 800C support dynamic pool allocation. This is handled via the use of one or more priority ID bits, with the number of bits depending on the desired priority granularity to be implemented. For example, partitioning of a cache into a high- and low-priority pool will require a single priority bit, while partitioning a cache into m pools will require log₂(m) priority ID bits (e.g., 2 bits for 4 priority level, 3 bits for 8 priority levels, etc.). Since the size of the cache groups are constant, an increase in the pool allocation of one priority level will result in a similar decrease to another pool.

Under cache architecture 800A of FIG. 8a, a single priority bit field is added to each TAG array entry resulting in a priority bit column 812. In response to an access request, a priority bit 810 is provided along with the address to the cache controller. The TAG array 712 may then be searched using the values in priority bit column 812 as a mask, thus improving the lookup. In response to a cache miss, a cache line from the applicable cache pool (as defined by the priority bit in cache architecture 800A and the priority ID bits in cache architectures 800B and 800C) is evicted using the pools eviction policy. The eviction policies include a low-priority eviction policy 820 and a high priority eviction policy 818 for cache architecture 800A, and m eviction policies 820₁₋ₘ for cache architectures 800B and 800C. As an option, a single cache policy (implemented separately for each pool) may be employed for each of these cache architectures, as depicted by common cache policy 824.

In conjunction with the cache line eviction selection, the requested data is retrieved from lower level 722 in a similar manner to that described above for cache architectures 700A and 700B. The applicable block is then copied into an appropriate cache line from among cache line array 714, and then the appropriate word (corresponding to the request address) is selected via a word selection multiplexer 814 and returned to input register 726.

In each of embodiments 800A, 800B, and 800C, the size of each pool is managed by a pool size selector 830. The pool size selector employs logic (e.g., an algorithm implemented via programmed logic) to dynamically change the size of the pools in view of cache activities. For example, the logic may monitor cache eviction activities in the respective pools to see if one or more of the pools is being evicted too often. In this case, it may be advantageous to increase the size of that pool, while decreasing the size of another or other pools.

The mechanism to effect a change in the size of a pool is fairly simple, while the process used for selecting cache lines to upgrade or downgrade is generally more complex. For example, to change the priority level of a given cache line, the line's corresponding priority bit (or priority ID bits) in the TAG array is/are simply changed to reflect the new priority level. Meanwhile, in one embodiment, selected cache lines are chosen for priority upgrade or downgrade in view of cache activity information, such as information maintained by an LRU or pseudo LRU algorithm. In another embodiment, sequential groups of cache lines may be replaced.

Cache architectures 800B and 800C are identical except for one field. Rather than employ a valid bit, cache architecture 800C employs a 2-bit MESI field, which supports the MESI (Modified Exclusive Shared Invalid) protocol. The MESI protocol is a formal mechanism for employing cache coherency via snooping, and is particularly useful in multiprocessor architectures. Under the MESI protocol, each cache line is assigned one of four MESI states.

A (M)odified-state line is available in only one cache and it is also contains data that has been modified—that is, the data is different than the data at the same address in system memory. An M-state line can be accessed without sending a cycle out on the bus.

An (E)xclusive-state line is also available to only one cache in the system, but the line is not modified. An E-state line can be accessed without generating a bus cycle. A write to an E-state line causes the line to become modified.

A (S)hared-state line indicates that the line is potentially shared with other caches (i.e., the same line may exist in more than one cache. A read to an S-state line does not F generate bus activity, but a write to a Shared line generates a write-through cycle on the bus. This may invalidate this line in other caches. A write to an S-state line updates the cache. Writes to S state lines will cause the bus to issue a Read For Ownership (RFO, zero-byte read) which will cause other caches to invalidate the line and transition this line to the Exclusive state. The write may then proceed to the E state line as described above.

An (I)nvalid-state indicates that the line is not available in the cache. A read to this line will result in a MISS and may cause the processor to execute a line fill (fetch the line from system memory). In one embodiment, a write to an Invalid line causes the processor to execute a write-through cycle to the bus. In one embodiment, a write to an “I” state line in writeback memory will cause a memory read on the bus to allocate the line in the cache. This is an “allocate on write” policy.

It is noted that for an instruction cache, only 1 bit is required for two possible states (SI) in the MESI protocol. This is because an instruction cache is inherently write-protected. In a similar manner to that employed in cache architecture 800C, MESI fields may be employed in place of valid bit fields in each of cache architectures 700A, 700B, 700C, and 800A.

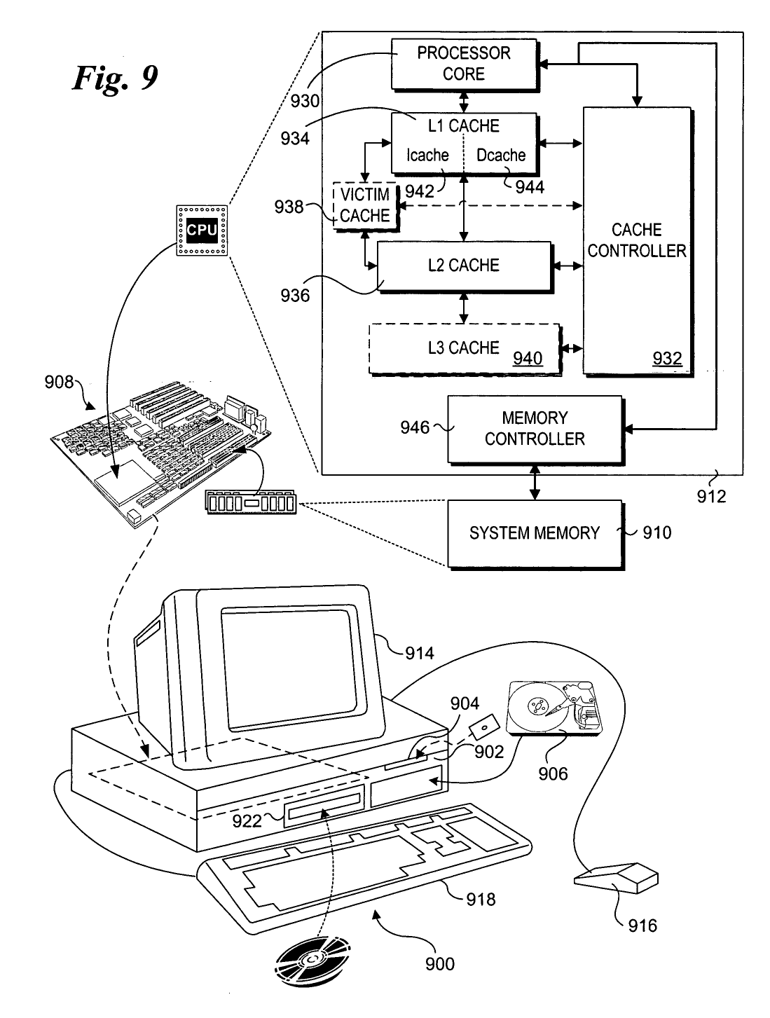

With reference to FIG. 9, a generally conventional computer 900 is illustrated, which is representative of various computer systems that may employ processors having the cache architectures described herein, such as desktop computers, workstations, and laptop computers. Computer 700 is also intended to encompass various server architectures, as well as computers having multiple processors.

Computer 900 includes a chassis 902 in which are mounted a floppy disk drive 904 (optional), a hard disk drive 906, and a motherboard 908 populated with appropriate integrated circuits, including system memory 910 and one or more processors (CPUs) 912, as are generally well-known to those of ordinary skill in the art. A monitor 914 is included for displaying graphics and text generated by software programs and program modules that are run by the computer. A mouse 916 (or other pointing device) may be connected to a serial port (or to a bus port or USB port) on the rear of chassis 902, and signals from mouse 916 are conveyed to the motherboard to control a cursor on the display and to select text, menu options, and graphic components displayed on monitor 914 by software programs and modules executing on the computer. In addition, a keyboard 918 is coupled to the motherboard for user entry of text and commands that affect the running of software programs executing on the computer.

Computer 900 may also optionally include a compact disk-read only memory (CD-ROM) drive 922 into which a CD-ROM disk may be inserted so that executable files and data on the disk can be read for transfer into the memory and/or into storage on hard drive 906 of computer 900. Other mass memory storage devices such as an optical recorded medium or DVD drive may be included.

Architectural details of processor 912 are shown in the upper portion of FIG. 9. The processor architecture includes a processor core 930 coupled to a cache controller 932 and an L1 cache 934. The L1 cache 934 is also coupled to an L2 cache 936. In one embodiment, an optional victim cache 938 is coupled between the L1 and L2 caches. In one embodiment, the processor architecture further includes an optional L3 cache 940 coupled to L2 cache 936. Each of the L1, L2, L3, and victim caches are controlled by cache controller 932. In the illustrated embodiment, L1 cache employs a Harvard architecture including an Icache 942 and a Dcache 944. Processor 912 further includes a memory controller 946 to control access to system memory 910.

In general, cache controller 932 is representative of a cache controller that implements cache control elements of the cache architectures described herein. In addition to the operations provided by the cache architecture embodiments described herein to support programmatic control of cache eviction policies, cache controller performs well-known conventional cache operations known to those skilled in the processor arts.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
enabling one of a programmer or compiler to delineate portions of code for which corresponding cache eviction policies for a cache are to be employed; and
employing the cache eviction policies as delineated by the programmer or compiler during runtime execution of the code to evict cache lines from the cache

2. The method of claim 1, further comprising:
enabling a programmer to define portions of source-level code for which a specified cache eviction policy is the be applied; and
compiling the source-level code into machine code, wherein the machine code includes instructions to assist in applying the specified cache eviction policy to corresponding portions of machine code derived from the portions of source-level code for which the specified cache eviction policy is to be applied.

3. The method of claim 2, wherein the programmer is enabled to define the portions of source-level code for which the specified cache eviction policy is to be applied by inserting statements in the source-level code to delineate those portions.

4. The method of claim 2, further comprising:
enabling the programmer to assign a first priority level to selected portions of the source-level code, wherein other portions of source-level code are assigned a second default priority level by default; and
in response to cues contained in the machine code,
applying a first cache eviction policy for data and/or instructions pertaining to machine code derived from the selected portions of source-level code to which the first priority was assigned, while applying a second cache eviction policy for data and/or instructions pertaining to machine code derived from the other portions of the source-level to which the default priority level was assigned.

5. The method of claim 2, further comprising:
enabling the programmer to assign respective priority levels to selected portions of the source-level code, the respective priority levels comprising at least three different priority levels;
in response to cues contained in the machine code,
applying, for portions of source-level code assigned to each priority level, a respective cache eviction policy for data and/or instructions pertaining to machine code derived from those portion of source-level code.

6. The method of claim 1, further comprising:
partitioning a cache into multiple priority pools having different priority levels; and
selectively caching a cache line in a particular priority pool designated by at least one cue contained in a portion of code referencing data and/or instructions contained in the cache line.

7. The method of claim 6, further comprising:
applying a respective cache line eviction policy for each respective priority pool.

8. The method of claim 6, wherein the cache comprises an n-way set associative cache having n sets, the method further comprising:
partitioning the cache into multiple priority pools by assigning a respective priority pool to each of the n sets.

9. The method of claim 6, further comprising:
maintaining indicia for each cache line identifying a priority pool assigned to that cache line.

10. The method of claim 6, further comprising:
enabling the size of selected priority pools to be dynamically changed during program code execution.

11. The method of claim 6, further comprising:
providing an instruction set that includes instructions to assign cache lines to selected cache pools.

12. The method of claim 11, wherein the instruction set includes instructions to assign a cache line to a cache pool having a specific priority level.

13. The method of claim 11, wherein the instruction set includes instructions to set one of a flag or multi-bit register that is used to assign a cache line to a cache pool having a specific priority level.

14. The method of claim 1, further comprising:
enabling said one of the programmer or compiler to specify use of a specific cache eviction policy for a selected portion of the machine code by using assembly language instructions corresponding to the machine code.

15. The method of claim 1, further comprising:
observing memory access patterns for portions of an application program;
determining portions of the application program for which a specific cache eviction policy is to be applied;
marking those portions of the application program; and
re-compiling the application program to generate machine code including op codes used to assist in applying the specific cache eviction policy for portions of the application program that were marked.

16. The method of claim 15, wherein determining the portions of the application program for which a specific cache eviction policy is to be applied and marking those portions is automatically performed by a code tuning tool.

17. The method of claim 1, wherein the cache comprises a first level (L1) cache.

18. The method of claim 1, wherein the cache comprises a second level (L2) cache.

19. The method of claim 1, wherein the cache comprises a third level (L3) cache.

20. A processor, comprising:
a processor core;
a cache controller, coupled to the processor core;
a first cache, controlled by the cache controller and operatively coupled to receive data from and to provide data to the processor core, the cache including at least one TAG array and at least one cache line array,
wherein the cache controller is programmed to partition the first cache into a plurality of pools, and apply a respective cache eviction policy for each pool.

21. The processor of claim 20, wherein the first cache comprises a first level (L1) cache, coupled to the processor.

22. The processor of claim 20, wherein the first cache comprises a second level (L2) cache, the processor further comprising:
a first-level (L1) cache, coupled between the processor and the L2 cache and controlled by the cache controller.

23. The processor of claim 20, wherein the cache includes at least one pool identifier (ID) bit associated with each cache line, the at least one pool ID bit used to designate the pool to which the cache line is assigned.

24. The processor of claim 23, wherein the cache controller is programmed to enable the at least one pool ID bit for a cache line to be changed in response to an input received from the processor core to dynamically change the size of at least one pool.

25. The processor of claim 20, wherein the cache comprises an n-way set associative cache.

26. The processor of claim 25, wherein the n-way set associative cache includes n groups of cache lines, each group of cache lines being associated with a different pool, and wherein the cache controller provides a respective cache eviction policy for each pool.

27. The processor of claim 20, wherein the processing core supports execution of an instruction set including at least one memory access instruction including a cue to designate a pool to which a cache line containing data and/or instructions located at a memory address referenced by the memory access instruction is to be assigned, and wherein execution of such a memory access instruction by the processing core causes operations to be performed including:
in response to a cache miss, determining a pool to which a new cache line is to be assigned based on the cue in the memory access instruction;
selecting an existing cache line to evict from the pool that is determined using a cache eviction policy assigned to the pool;
retrieving a block of data to be inserted into a cache line, the block of data including data and/or instructions stored in system memory at an address referenced by the memory access instruction; and
copying the block of data into the cache line that was selected for eviction.

28. A computer system comprising:
memory, to store program instructions and data, comprising SDRAM (Synchronous Dynamic Random Access Memory);
a memory controller, to control access to the memory; and
a processor, coupled to the memory controller, including,
a processor core;
a cache controller, coupled to the processor core;
a first-level (L1) cache, controlled by the cache controller and operatively coupled to receive data from and to provide data to the processor core; and
a second-level (L2) cache, controlled by the cache controller and operatively coupled to receive data from and to provide data to the processor core,
wherein the cache controller is programmed to partition at least one of the L1 and L2 caches into a plurality of pools, and apply a respective cache eviction policy for each pool.

29. The computer system of claim 28, wherein the L2 cache comprises:
an n-way set associative cache includes n groups of cache lines, each group of cache lines being associated with a different pool, and wherein the cache controller provides a respective cache eviction policy for each pool.

30. The computer system of claim 28, wherein the L1 cache comprises a Harvard architecture including an instruction cache and a data cache, and wherein the instruction cache controller is programmed to partition cache lines for the instruction cache into a plurality of pools, the cache controller using a respective cache line eviction policy for each pool.
